(19) United States
(12) Patent Application Publication
(10) Pub. No.: US 2015/0327721 A1
(43) Pub. Date: Nov. 19, 2015

(54) Marshmallow Toasting Device

(71) Applicant: Edward Appleton Gaylor, Little Falls, NJ (US)

(72) Inventor: Edward Appleton Gaylor, Little Falls, NJ (US)

(21) Appl. No.: 14/280,590

(22) Filed: May 17, 2014

(51) Int. Cl. A47J 33/00

(52) U.S. Cl. CPC A47J 33/00

(57) ABSTRACT

My Marshmallow Toasting Device is an invention which deals with the problem of toasting marshmallows over an open fire in an effective, inexpensive manner. The problem is to invent a device that allows several people to use their own personal toasting device over the same fire at the same time; while at the same time the device needs to be lightweight, inexpensive, reusable, and yet be disposable (in part) for easy cleanup. My Marshmallow Toasting Device solves the above problem and basically consists of a lightweight holding rod which is capable of easily accepting a disposable skewer being inserted into one end of it.

### BACKGROUND OF INVENTION

(1) Field of the Invention

This invention pertains to the field of endeavor relating to cooking marshmallows over an open flame, particularly by a group of people.

(2) Description of Related Art

U.S. Pat. No. 6,877,232 (Harmon, et all, Apr. 12, 2005)—It could be said that any cooking utensil with a method for holding a marshmallow for the purposes of cooking it over an open flame would be related to my invention. The problem with this invention is that it is not practicable. Do people normally really cook marshmallows with an expensive device one at a time or in group?—Normally, it's within a group of people. This device has the problem of being relatively expensive to make, and therefore it is not practicable for a large group of people to use several of these devices at the same time. Also, the portion of this device that is used to hold the marshmallow attaches in a very different manner than my invention and is not disposable, and therefore requires cleanup after use.

U.S. Pat. No. 7,234,392 (Arndt, Jun. 26, 2007)—It could be said that any cooking utensil with a method for holding a marshmallow for the purposes of cooking it over an open flame would be related to my invention. The problem with this invention is that it is not practicable. Do people normally really cook marshmallows with an expensive device one at a time or in group?—The answer is of course, they normally cook them in a group. The design of this device is quite different from mine and I only mention it because it is the only invention I could find that mentions (as an afterthought) the possibility of using a disposable skewer in the Description Of

The Invention section (not in the Claims). It still has the problem of being relatively expensive to make (most components are of stainless steel), and therefore it is not practicable for a large group of people to use several of these devices at the same time.

U.S. Pat. No. 6,009,796 (Larzik, Jan. 4, 2000)—It could be said that any cooking utensil with a method for holding a marshmallow for the purposes of cooking it over an open flame would be related to my invention. The problem with this invention is that that the portion of the device used for holding the marshmallow is not disposable. The material to be used for the skewer is said to be pine, which is not a slow burning wood as stated, and it is suggested that the wood be soaked in water prior to each use to prevent it from catching on fire (this is so that it can be re-used each time). Although this device would seem to have the required length that the other devices (U.S. Pat. No. 6,877,232—Harmon and U.S. Pat. No. 7,234,392—Arndt) mentioned above do not—for cooking by a group of people a safe and reasonable distance from an open fire; the non-disposable skewer itself is too long (35″) and would be prone to getting broken with its given thickness; and of course, this device requires cleanup of the skewer after each use, whereas my invention does not.

In general, none of these patents (U.S. Pat. No. 6,877,232—Harmon Apr. 12, 2005, U.S. Pat. No. 7,234,392—Arndt Jun. 26, 2007, U.S. Pat. No. 6,009,796—Larzik—Jan. 4, 2000) have all of the aspects that my invention does which include a device which is lightweight, long enough for easy use by a several people at the same time, inexpensive, and reusable and disposable (in part) at the same time.

### BRIEF SUMMARY OF THE INVENTION

When it comes to a marshmallow toasting device, seems like everyone out there is trying to “invent a better mousetrap”. i.e. Everyone is trying to improve upon the traditional marshmallow toasting device—which is of course, a carefully selected stick found in the woods, with one end shaved down into a point with a jack knife It is hard to improve on this device.—It has almost all of the assets that are required. It's light for easy control, it's long so that several people can grille their marshmallows at the same time, it's disposable for easy cleanup, and last but not least, it's inexpensive which makes it practicable.

So how to improve upon this age-old, tried and true device?—My invention. My invention incorporates all of the above mentioned assets (light, long, disposable, and inexpensive) while adding the feature that a portion of it is reusable.

### BRIEF DESCRIPTION OF THE SEVERAL VIEWS OF THE DRAWING(S)

FIG. 1 illustrates my Marshmallow Toasting Device's 2 components:
(A) the HOLDING ROD
and
(B) the SKEWER.
The HOLDING ROD (A) has a Hole (C) in one end which is designed to accept the insertion of the SKEWER (B). Either end of the SKEWER (B) can be inserted into the Hole (C) of the HOLDING ROD (A). Namely, either the Pointed End (D) or opposite end (Blunt End (E)) of the SKEWER (B) can be inserted into the Hole (C) of the HOLDING ROD (A). The diameter of the SKEWER (B) at Point F is the same as the diameter of the SKEWER (B) at the Blunt End (E) and is where (at Point F) the taper of the Pointed End (D) begins. The diameter of the SKEWER (B) is uniform from Blunt End (E) to Point (F).
A working Marshmallow Toasting Device is available for shipment to the examining attorney immediately upon request.

FIG. 2 illustrates my Marshmallow Toasting Device assembled with the Blunt End (E) (as opposed to the Pointed End (D)) of the SKEWER (B) inserted into the Hole (C) of the HOLDING ROD (A).

FIG. 3 illustrates my Marshmallow Toasting Device assembled with the Pointed End (D) (as opposed to the Blunt End (E)) of the SKEWER (B) inserted into the Hole (C) of the HOLDING ROD (A). This could be useful if younger children are involved with the use of the device for safety reasons.

### DETAILED DESCRIPTION OF THE INVENTION

My invention takes into account the following:

As illustrated in FIG. 1 my Marshmallow Toasting Device consists of 2 components:

(A) the HOLDING ROD
and
(B) the SKEWER.
The HOLDING ROD (A) has a Hole (C) in one end which is designed to accept the insertion of the SKEWER (B). Either end of the SKEWER (B) can be inserted into the Hole (C) of the HOLDING ROD (A). Namely, either the Pointed End (D) or opposite end (Blunt End (E)) of the SKEWER (B) can be inserted into the Hole (C) of the HOLDING ROD (A).
The diameter of the Hole (C) in the HOLDING ROD (A) should be only slightly greater than the diameter of the SKEWER (B) at the blunt end (E).—Meaning that the diameter of the Hole (C) should be such that the diameter of the Blunt End (E) of the SKEWER (B) will allow the SKEWER (B) to be inserted Blunt End (E) first into the Hole (C) easily but also snugly at the same time. That is, it should be easy to insert the SKEWER (B) (Blunt End (E) first) into the Hole (C) where it is not prone to falling out during normal use; but at the same time, easy to remove. The depth of the Hole (C) in the HOLDING ROD (A) should be such that it also complies with the same rule that is applied to the relationship of the 2 above diameters (diameter of the Hole (C) and the diameter of the Blunt End (E) of the SKEWER (B)); that is, it should be easy to insert the SKEWER (B) (Blunt End (E) first) into the Hole (C) where it is not prone to falling out during normal use; but at the same time, easy to remove. The total combined length of the HOLDING ROD (A) and the SKEWER (B) should be long enough such that it allows several people to be toasting marshmallows around a fire at the same time, but not being so long such that the device is unwieldy; while at the same time not being so short that the people toasting the marshmallows are too close to the heat of the fire.
Suggested length for the HOLDING ROD (A) would be 24 inches.
Suggested diameter for HOLDING ROD (A) would be ⅜ inch.
Suggested material for HOLDING ROD (A) would be a hardwood dowel (like Oak or Maple).
Suggested diameter for the Hole (C) would be ⅛ inch (0.125″).
Suggested depth for the Hole (C) would be 1⅛ inches (1.125″).
Suggested length for the SKEWER (B) would be 12 inches.
Suggested diameter for the SKEWER (B) at the Blunt End (E) would be 3 mm (approximately 0.11811″)
Suggested length from Pointed End (D) of SKEWER (B) to Point (F) would be ½ inch.
Suggested material for the SKEWER (B) would be bamboo.
Skewers for cooking are currently manufactured and produced in the billions, and are readily available and extremely inexpensive. The above suggestion for the dimensions and material for the SKEWER (B), along with the specified dimensions for the HOLE (C) are to take advantage of this fact.
A working Marshmallow Toasting Device is available for shipment to the examining attorney immediately upon request.

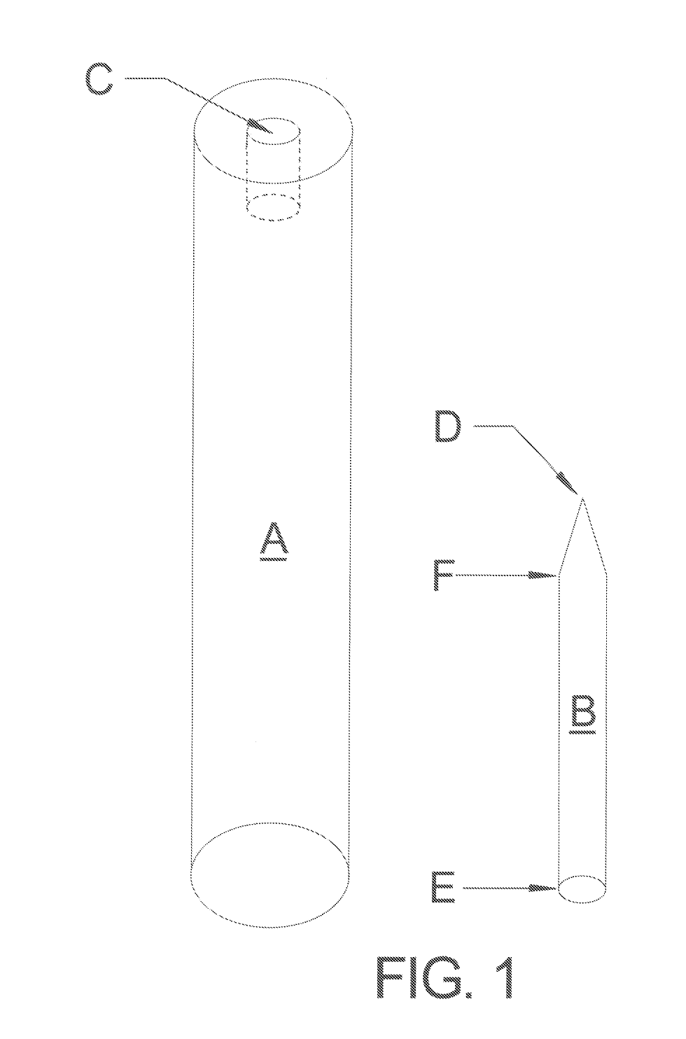

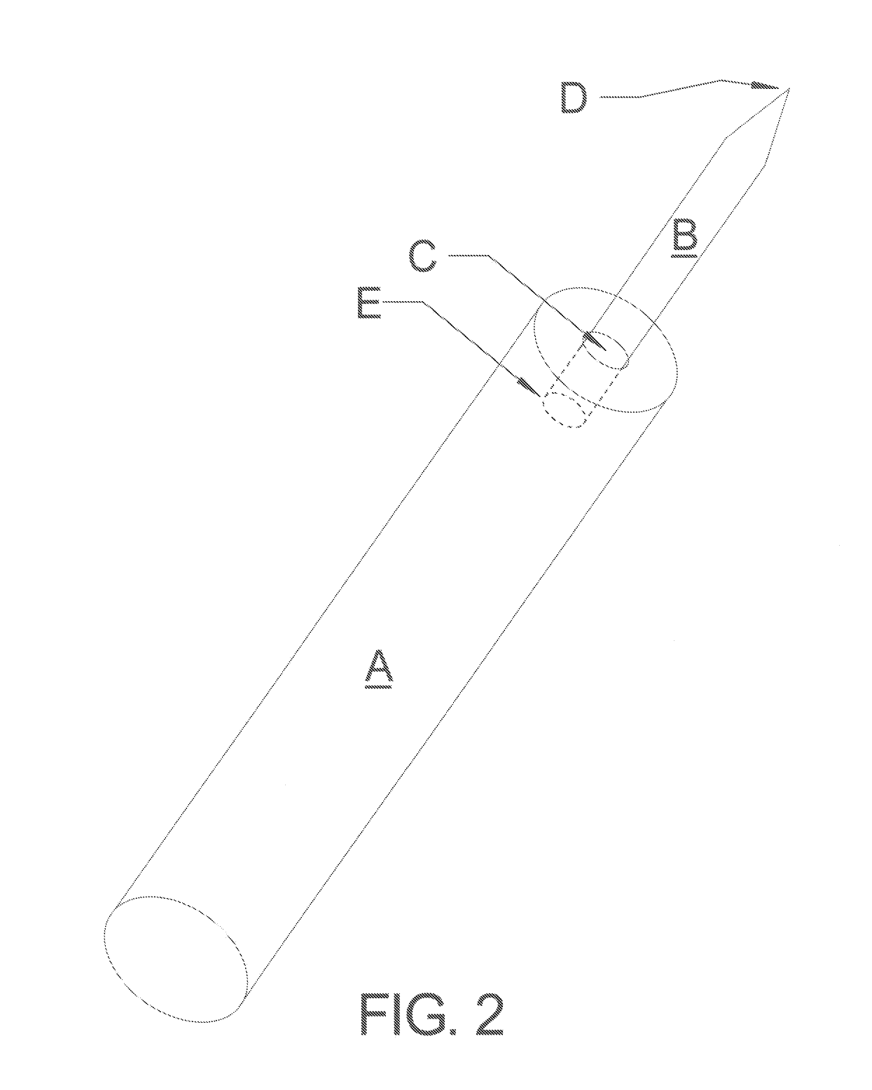

As illustrated in FIG. 2 my Marshmallow Toasting Device is assembled with the Blunt End (E) (as opposed to the Pointed End (D)) of the SKEWER (B) inserted into the Hole (C) of the HOLDING ROD (A). It is also possible for the SKEWER (B) to have a slightly smaller diameter (say 2.5 mm) at the Blunt End (E) than suggested (3 mm) in the description of FIG. 1.—This will also work; as long as this diameter of SKEWER (B) is not so much smaller than the diameter of the Hole (C) that it is too loose and will fall out on its own. This gives the flexibility of the Hole (C) in the HOLDING ROD (A) being able to accept a SKEWER (B) with a diameter at the Blunt End (E) which is even a little more slightly smaller (than as suggested in the description for FIG. 1) than the diameter of the Hole (C).—That is, a SKEWER (B) with a diameter at the Blunt End (E) of 2.5 mm, could still easily be inserted Blunt End (E) first into the Hole (C) if the diameter of the Hole (C) were ⅛ inch. This gives great flexibility for the device being able to use already manufactured, inexpensive skewers which are slightly smaller in diameter than the recommended dimension in the description given for FIG. 1.

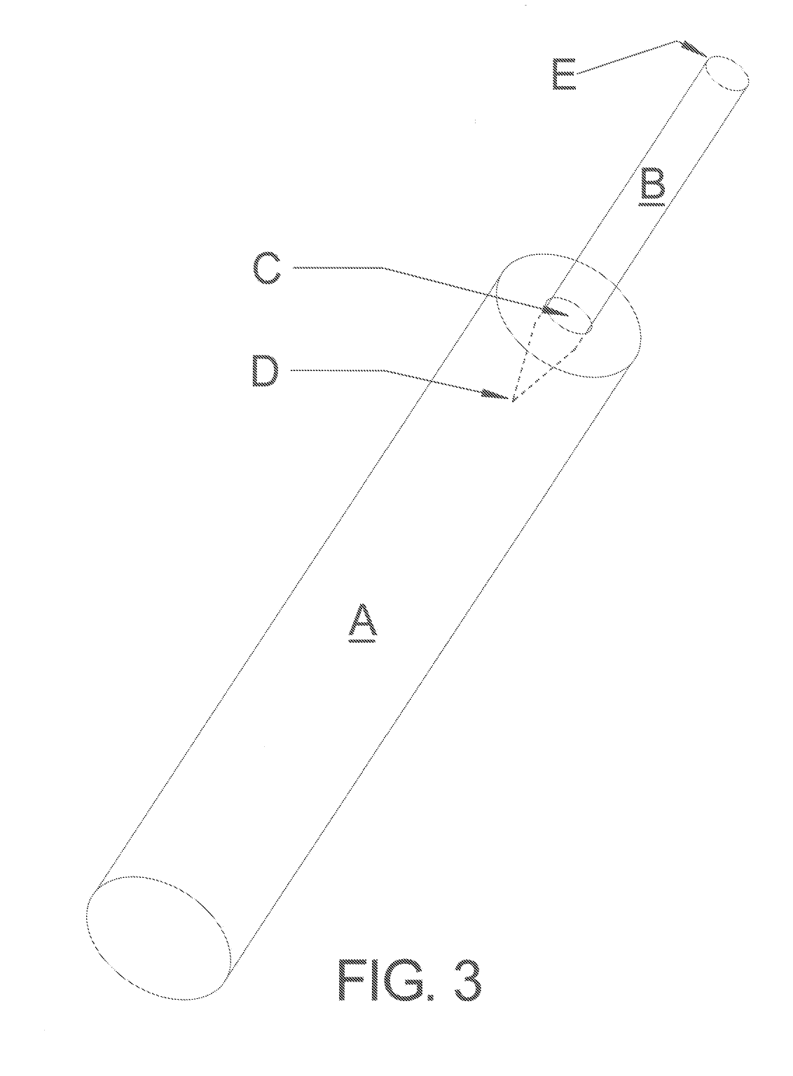

As illustrated in FIG. 3 my Marshmallow Toasting Device is assembled with the Pointed End (D) (as opposed to the Blunt End (E)) of the SKEWER (B) inserted into the Hole (C) of the HOLDING ROD (A). This could be useful if younger children are involved with the use of the device for safety reasons. Also, this gives the flexibility of the Hole (C) in the HOLDING ROD (A) being able to accept a SKEWER (B) with a diameter at the Blunt End (E) which is slightly larger than the diameter of the Hole (C).—That is, a SKEWER (B) with a diameter at the Blunt End (E) of 4 mm, could still easily be inserted Pointed End (D) first into the Hole (C) if the diameter of the Hole (C) was ⅛ inch. Again, this gives great flexibility for the device being able to use already manufactured, inexpensive skewers which are slightly larger in diameter than the recommended dimension (3 mm) in the description given for FIG. 1.

What I claim as my invention is the following:

1. A marshmallow toasting device which is comprised of two basic components: a holding rod and a disposable skewer, where the holding rod has a hole in one end which is capable of accepting either the pointed or blunt end of the skewer being inserted into it in such a manner as it is easy to insert and remove, while at the same time fitting snugly enough as to not fall out during the normal use of toasting a marshmallow over an open fire.

2. A holding rod and skewer in claim 1 where the total combined length and weight of the holding rod and the skewer is long and light enough such that it allows several people to be toasting marshmallows around a fire at the same time, but not being so long such that the device is unwieldy; while at the same time not being so short that the people toasting the marshmallows are too close to the heat of the fire.

3. A holding rod in claim 1 which is fabricated from a hardwood dowel of either oak or maple and whose recommended length is 24 inches and whose recommended diameter is ⅜ inch.

4. A holding rod in claim 1 where there is a hole in one end where the hole has a recommended diameter of ⅛ inch and a recommended depth of 1⅛ inches (1.125″).

5. A holding rod in claim 1 where there is a hole in one end where the hole is able to easily have inserted and removed when done, a 3 mm diameter disposable skewer, to take advantage of the millions upon millions of these skewers which are available today on the open market—and are extremely inexpensive.

6. A skewer in claim 1 where one end of the skewer is pointed and one end is blunt.

7. A skewer in claim 1 which is fabricated from bamboo and whose recommended length is 12 inches and whose recommended diameter at the blunt end is 3 mm, and whose recommended diameter ½ inch in from the pointed end is 3 mm, tapering to 0.1 mm at the pointed end.
